(19) United States
(12) Patent Application Publication
(10) Pub. No.: US 2025/0007256 A1
(43) Pub. Date: Jan. 2, 2025

(54) Gear Base

(71) Applicant: Seekells Innovations LLC, Kuna, ID (US)

(72) Inventor: Seekell Robert, Kuna, ID (US)

(21) Appl. No.: 18/757,353

(22) Filed: Jun. 27, 2024

Related U.S. Application Data
(60) Provisional application No. 63/510,574, filed on Jun. 27, 2023.
(60) Provisional application No. 63/515,586, filed on Jul. 25, 2023.

(51) Int. Cl. H02G 1/02

(52) U.S. Cl. CPC H02G 1/02

(57) ABSTRACT

A gear base mounts to a cross arm or electrical pole and allows for pivotal adjustment of a hot arm positioned within a connector of the base. The hot arm is a nonconductive pole having a head for engaging an electrical conductor. The gear base has a worm gear assembly that allows for actuated pivoting adjustment of the hot arm to the base of the gear base. The gear base and hot arm assembly allows for positioning an energized conductor away from the power pole or hot arm, and allows for tool controlled adjustment of the position of the conductor relative to pole or cross arm.

### CROSS-REFERENCE TO RELATED APPLICATIONS

This application claims the benefit of U.S. Provisional Application No. 63/510,574, filed Jun. 27, 20, and U.S. Provisional Application No. 63/515,586, filed Jul. 25, 2023, the disclosure of each of which is incorporated by reference.

### FIELD OF INVENTION

This invention relates to mechanical manipulation of conductors in electrical power distribution. The connector relative to the base for use with moving and energized conductor left or right. This tool will be for new construction rebuild or maintenance tasks. Rotating the connector relative to the base is for use with conductor support tools and conductor rigging gins to help lift a conductor or manipulate a conductor left or right.

### BACKGROUND OF THE INVENTION

Electric power distribution is the final stage of the power delivery system before voltage gets stepped down to useable secondary voltage (120/240) (277/480) 480 volts to customer's meters.

Electricity is created at generation facilities across the world. In the US, voltage is generated at 13.8 kv to 24 kv and immediately stepped up to high higher transmission voltages, up to 500 kv and higher. The use of transformers helps make this happen where the voltages are stepped up and down.

The generation stations in the US are tied together through transmission systems referred to as “the Grid”. Transmission systems move large quantities of power over long distances at higher voltages to transmission substations where the voltage is stepped down to lower voltages.

The lower voltage is referred to as sub transmission voltage ranging from 44 kv to 138 kv. The sub transmission structures are smaller and easier to install in populated areas. Some sub transmission is used to deliver power to large industrial customers.

Distribution substations are fed by sub transmission circuits where with the use of transformers, the voltage is stepped down to 2 kv up to 34.5 kv where it then leaves the substation and goes to residential neighborhoods.

The conductors in a power distribution system extend from support structure to support structure. The structures can be either wood poles, metal poles, lattice towers or fiberglass poles. These structures are referred to herein collectively as power poles. The poles often have horizontal components extending from the vertical pole. The horizontal components are referred to as cross arms. Most often on main lines, the structure will have four (4) conductors on each pole and sometimes double circuits that could be eight (8) or more conductors. The wires or conductor might run one to two (1-2) miles in town or about forty (40) poles per mile. In town distribution poles have an average spacing of about 132 feet.

When a worker is conducting maintenance on an existing system, there can be a need to move the conductor, while keeping the conductor energized to avoid disrupting the distribution system. When there are existing energized conductors on the crossarm or utility arm, line workers have to move the conductors while they are energized to fiberglass temp arms that attach to existing crossarm or utility arms. The reason for this step is to make room to install the rollers to the crossarm or utility arm to pull in the conductor.

Line workers today use hot sticks and nonconductive gins or poles to move and lift energize conductors. What is needed is a convenient way to manipulate the position of the conductor by keeping it 100% in mechanical control. This would be safer than current work methods being used today. Anytime a line worker is in the energized zone or close quarters to an energized conductor the work task would be safer if they move or pivot the conductor away from their body or working position. This would increase their minimum approach distance which is a standard that line workers must follow for company policy and OSHA rules and regulations for hotline maintenance.

### SUMMARY

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature

### BRIEF DESCRIPTION OF DRAWINGS

FIG. 1 is an isometric view of a gear base according to a preferred embodiment.

FIG. 2 is a top view of the gear base of FIG. 1.

FIG. 3 is a second isometric view of the gear base of FIGS. 1 and 2.

FIG. 4 is a side view of the gear base of FIGS. 1-3.

FIG. 5 is a front view of the gear base of FIGS. 1-4.

FIG. 6 is an isometric view of the gear base of FIGS. 1-5.

FIG. 7 is an isometric view of the gear base of FIGS. 1-6.

FIG. 8 is a front view of a second preferred embodiment of a gear base having a cylindrical socket for receiving a pole of a hot arm.

FIG. 9 illustrates the gear base of FIG. 8 and a hot arm and connector pin exploded from the socket.

FIG. 10 illustrates a side view of the gear base, pin, and hot arm of FIG. 9 in an assembled state.

FIG. 11 is a top view of a third preferred embodiment of the invention

FIG. 12 is a first isometric view of the embodiment of FIG. 11.

FIG. 13 is a second isometric view of the embodiment of FIGS. 11-12.

FIG. 14 is a side view of the embodiment of FIGS. 11-13.

FIG. 15 is a front view of the embodiment of FIGS. 11-14.

FIG. 16 is a third isometric view of the embodiment of FIGS. 11-15.

### DETAILED DESCRIPTION OF THE INVENTION

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

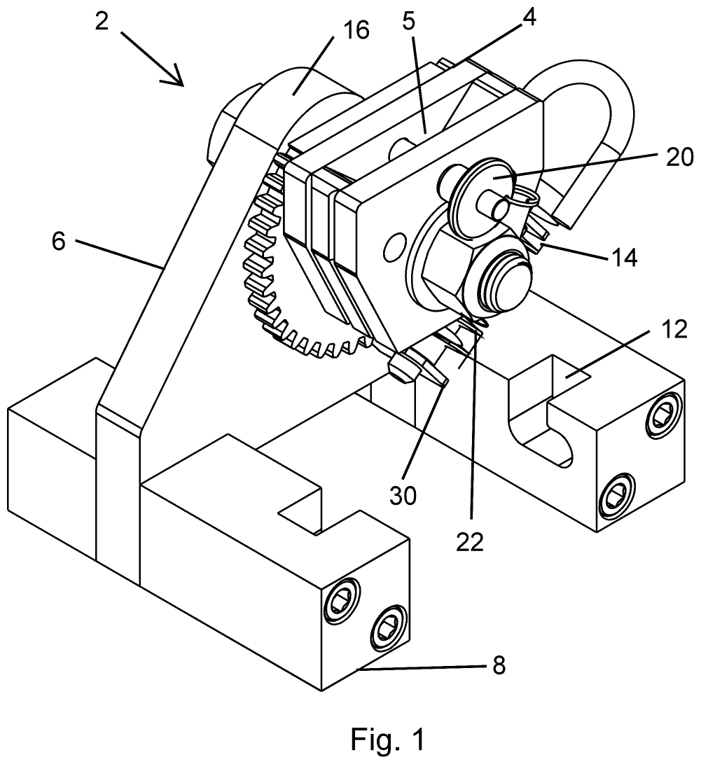

FIG. 1 illustrates a perspective view of an improved base and connector for mounting a hot arm to an electrical pole or cross arm. The connector and base has a connector 4 and a base 6. The connector 4 is pivotally attached to the base by pivot pin assembly 22. The pivot pin of the pivot pin assembly is positioned through the connector and base and secured by a nut at each end of the pivot pin. Each nut is threadably engaged with the pin to secure the connector to the base. The base is configured to be secured to a power pole or crossarm by a ratcheting strap, such as is disclosed by the inventor's U.S. Pat. No. 10,998,700.

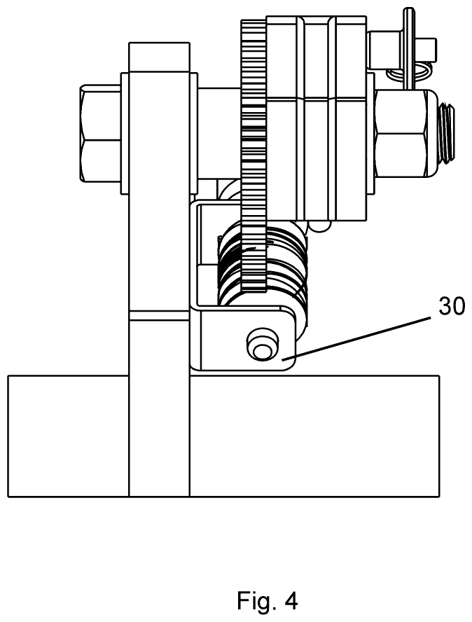

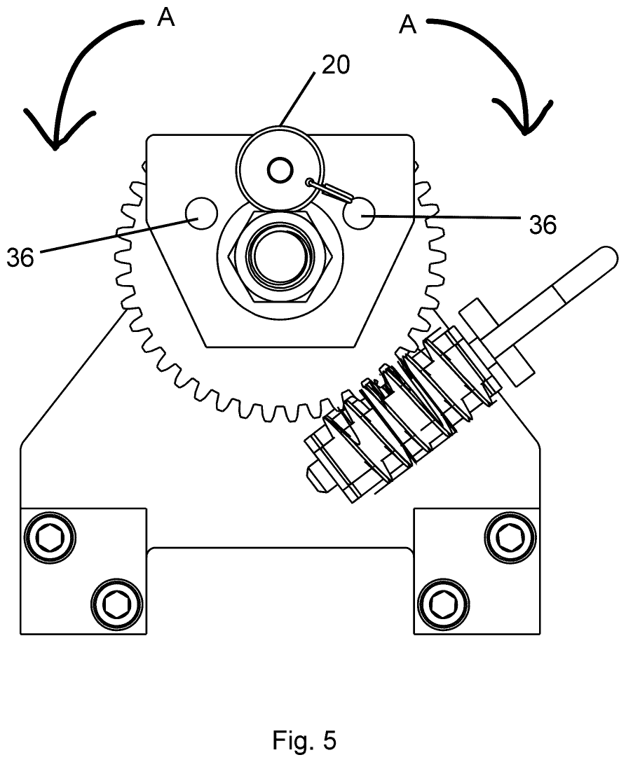

The connector is configured to rotate at the pivot assembly as shown by line A (FIG. 5). The connector has a ratchet wheel attached to or formed as the back of the connector. The ratchet wheel is operatively engaged with a worm mounted on the base. The worm (shown in further detail in FIGS. 3 and 5) has a shaft having a spiral thread on the outer circumference of the shaft. The spiral thread is configured for operational engagement with the ratchet wheel teeth of the connector. The depicted worm has a tab or ring 45 on the end of the shaft that is configured for a person to rotate the shaft of the worm, thus rotating the spiral threading causing rotation of the sprocket of the connector. The tab or ring can be on either side of the shaft of the worm or on both sides of the worm.

The connector is configured with a socket 5 into which the flange of a hot arm is positioned. The base assembly of the depicted embodiment is configured to attach to a power pole or crossarm attached thereto, as shown in U.S. Pat. No. 10,998,700, the contents of which are herein incorporated by reference.

The disclosed device utilizes a worm gear assembly for actuating rotation of the connector rative to the base. The worm gear assembly operatively connects the base and the connector to actuate the pivoting movement of the connector relative to the base. Preferably a worm is connected to the base, preferably at a rear or back wall of the base. The connector has a ratchet wheel, connected to or formed as part of the connector. Spiral threads extending from the circumference of the shaft of the worm rotate with the shaft of the worm and interact with the teeth of the ratchet wheel to cause rotation of the ratchet wheel and connector. One or more locking pins can be utilized to lock the connector in rotational position. The locking pin(s) that lock rotation can also be utilized to retain the hot arm in the socket, or a separate pin can be utilized. Alternatively a gear lock that interacts with the gear teeth of the ratchet wheel to arrest rotation of the ratchet wheel can be utilized. The term locking pin is referred to as meaning any device, including a pin or gear lock, that arrests rotation of the worm gear assembly.

The base is configured to be mounted to a power utility pole or cross-arm and to fix the base in place. The connector is pivotally adjustable relative to the base. The connector has one or more pin apertures 36. The depicted embodiment has three pin apertures for placement therethrough of a pin 20. The base preferably has a base pin aperture. As the connector rotates, each of the pin apertures on the connector progressively rotates. The three pin apertures provide three separate locking points at each position at which each pin aperture of the connector align with the base pin aperture. The insertion of pin 20 through one of the connector pin apertures, through an aperture of a flange of a hot arm. and into the base pin aperture. Multiple pins can be used to secure the connector in rotational position, and a separate pin can be used to secure a hot arm in the socket from the pin used to rotationally lock the connector in position. The pin secures the hot arm within the socket as well the position of the connector rotationally to the base. This allows a worker, such as a lineman, to rotate the connector thus adjusting the position of the hot arm pivotally connected to the base.

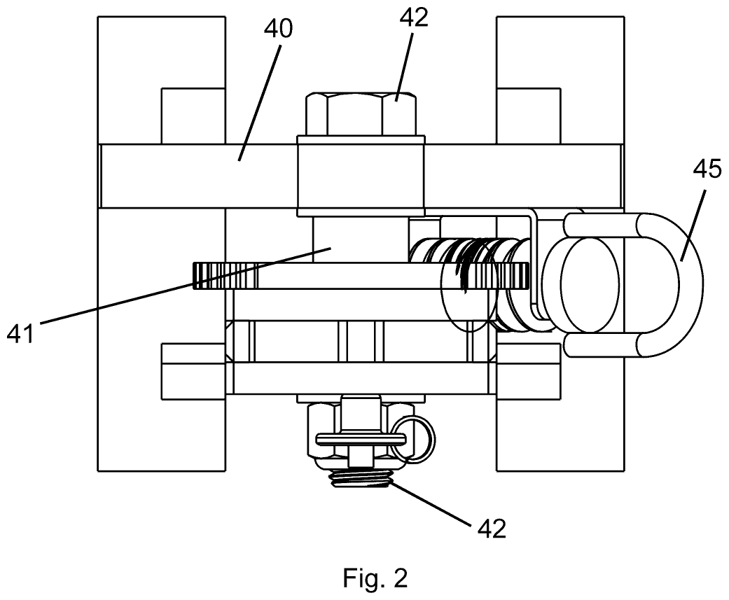

FIG. 2 illustrates a top view of the connector relative to the base. The pivot pin 41 extends from the front of the connector through the connector and ratchet wheel and into and through the face plate 40. The pivot pin is secured at each end by a nut 42 to secure the connector on the pivot pin to the face plate. The preferred embodiment is shown with a ring 45 so the user can grasp with the user's hand.

FIG. 3 illustrates a second perspective view of a preferred embodiment of the device showing the worm 13 in relation to the ratchet wheel 18 having teeth 19. The teeth of the sprocket gear are configured for rotational engagement with the threads 16 of the worm 14.

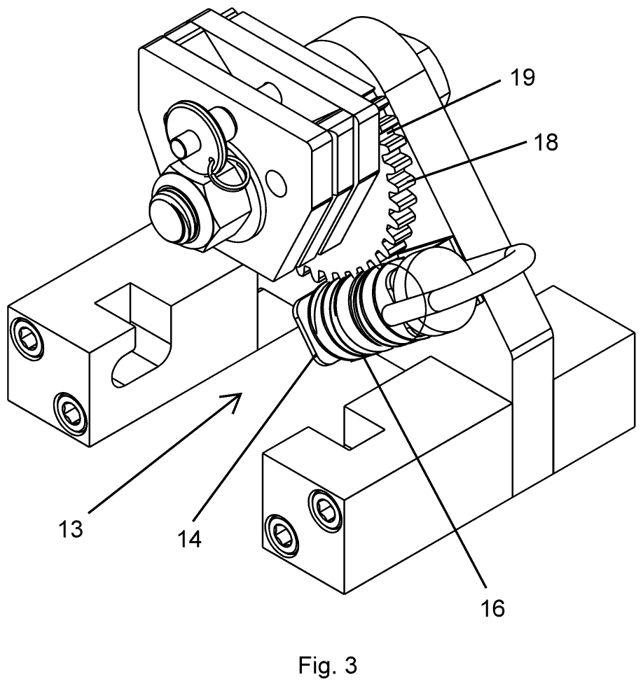

FIG. 4 illustrates a side view of the device shown in FIGS. 3-4 illustrating the attachment bracket 30 connecting the worm to the base plate. The attachment bracket allows the worm to rotate freely in place, thus allowing for rotation of the ratchet wheel relative to the base plate.

FIG. 5 illustrates the front view of the device showing the rotational movement as denoted by line A of the connector relative to the base.

FIG. 6 illustrates a perspective model view of the connector and base having a worm gear assembly as a rotational actuator.

FIG. 7 illustrates a second perspective model view of the connector and base having a worm gear assembly as a rotational actuator.

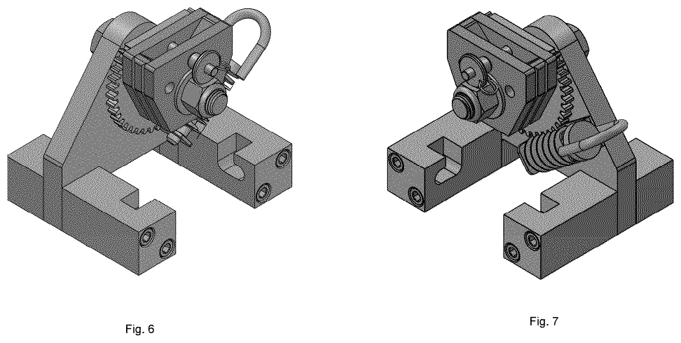

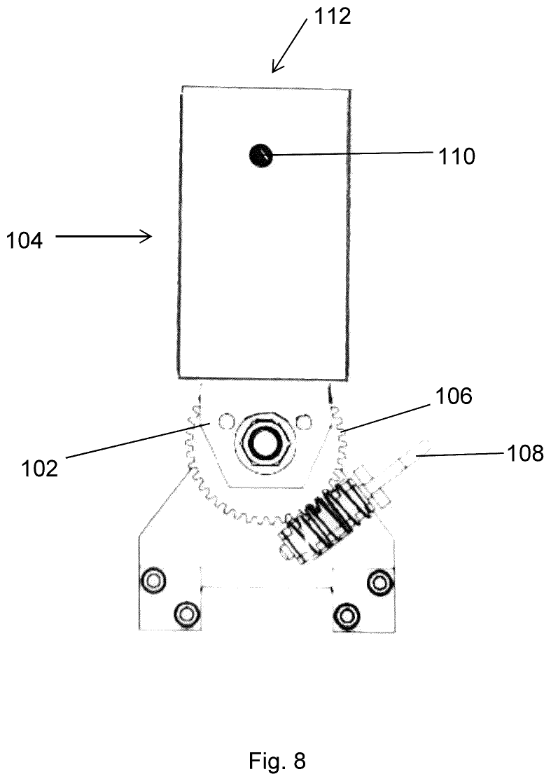

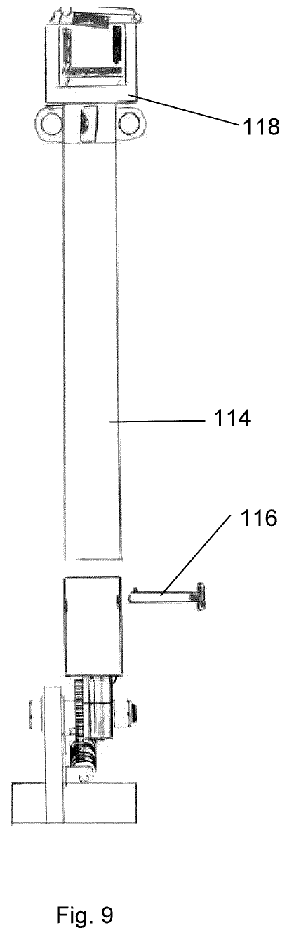

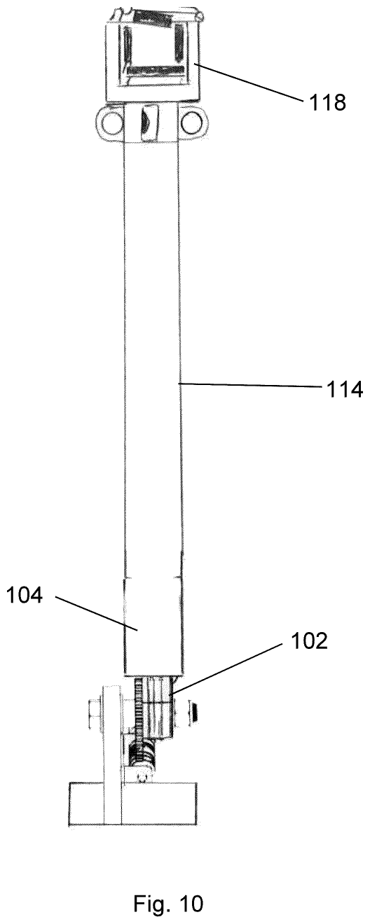

FIG. 8 illustrates an alternate embodiment of the socket of the connector being a cylindrical socket. While a cylindrical socket is shown, alternate shapes, such as a square or rectangular profiled socket may be used. The cylindrical socket 104 is formed as a part of or attached to the pivot component 102 of the connector. The connector has a ratchet wheel (also called a worm wheel) 106 that is driven by the worm 108. The cylindrical socket has an opening 112 at the top of the cylindrical socket for insertion of a cylindrical pole, such as a fiberglass pole of the inventor's hot arm. The depicted hot arm has a shaft inserted into the cylindrical socket at a first end, and is configured for securing a conductor at the second end (118 of FIGS. 9 and 10) of the pole. The cylindrical socket of FIG. 8 has a pin opening 110 through which a pin is inserted to secure a pole.

The hot arm can be affixed by a pin such as shown in the side view shown FIG. 9, or can be more permanently affixed in the cylindrical socket by an adhesive as shown in the side view shown in FIG. 10. Alternate embodiments that allow for affixation of a hot arm in the socket or socket are also contemplated by this disclosure. The hot arm can be formed integrally with the pivot component such that the hot arm has a pivoting component and gear wheel that connect to the base.

The hot arm shaft is a nonconductive material, preferably fiberglass, and an end of the fiberglass shaft is positioned in the socket or socket. The hot arm can be glued or otherwise permanently attached in the socket, or can be clamped in the socket.

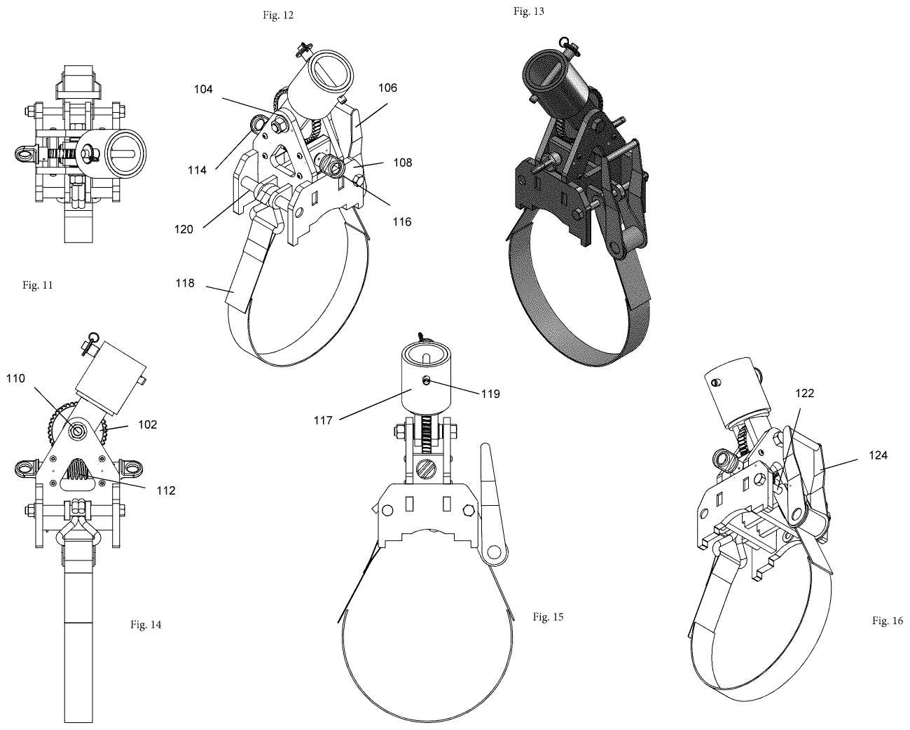

FIGS. 12-16 illustrate a third embodiment of the invention. The ratchet wheel 102 is positioned between two flanges 104, 106 of the base 108 that form a bracket in which the ratchet wheel 102 pivots. A pivot pin 110 extends through the ratchet wheel and is pivotally secured in each bracket. The worm 112 is positioned and configured to rotation the ratchet wheel. Two tabs 114, 116 positioned at opposite ends of the worm shaft are utilized by a worker to rotate the worm to drive rotation of the ratchet wheel. The depicted embodiment utilizes a cylindrical sleeve 117 or cup to secure the shaft of a hot arm (not depicted in FIGS. 12-16) in the cylindrical sleeve. A locking pin 119 secures the shaft of the hot arm in the cylindrical sleeve.

A ratchet strap 118 extends from a first ratchet strap bolt 120 connected to the base to a second ratchet strap bolt 122 connected to the base. The ratchet strap has ratchet lever 124 that is used to tension the ratchet strap around the utility pole or cross arm of the utility pole.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

What is claimed is:

1. A hot arm and base assembly for mounting the hot arm to an electrical pole or cross arm of the electrical pole, wherein said assembly comprising:
a base configured for mounting on a utility electrical pole or crossarm;
a hot arm comprising a nonconductive shaft and a head configured for manipulation of a conductor line of a power distribution system; and
a worm drive assembly comprising a ratchet wheel and a worm configured to drive rotation of said ratchet wheel, wherein said worm is connected to said base, wherein said hot arm is connected to said ratchet wheel such that rotation of said ratchet wheel causes pivotal rotation of said hot arm relative to said base.

2. The hot arm and base assembly of claim 1 further comprising a connector, wherein said hot arm is connected to said connector, wherein said connector connects said hot arm to said ratchet wheel.

3. The hot arm and base assembly of claim 1, wherein said nonconductive material is fiberglass.

4. The hot arm and base assembly of claim 1, wherein said worm comprises a shaft having at least one end tab configured for a user to grasp to rotate said worm.

5. The hot arm and base assembly of claim 2 wherein said conductor comprises a socket configured to receive a first end of said shaft of said hot arm.

6. The hot arm and base assembly of claim 1 further comprising a rotational locking pin configured to lock rotation of said worm gear assembly.

7. The hot arm and base assembly of claim 2 further comprising a hot arm locking pin configured to secure said hot arm in said connector.

8. The hot arm and base assembly of claim 5 wherein said socket comprises a cylindrical sleeve, wherein said shaft of said hot arm comprises a cylinder positioned within said cylindrical sleeve.
